(19) United States
(12) Patent Application Publication
(10) Pub. No.: US 2007/0296909 A1
(43) Pub. Date: Dec. 27, 2007

(54) DISPLAY DEVICE

(75) Inventors: Hitoshi Nagato, Tokyo (JP); Rei Hasegawa, Yokohama-shi (JP); Yasushi Shinjo, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/672,751

(22) Filed: Feb. 8, 2007

(30) Foreign Application Priority Data
Jun. 27, 2006 (JP) P2006-177255

(51) Int. Cl. G02F 1/1335; G02B 5/04

(52) U.S. Cl. 349/162; 359/837

(57) ABSTRACT

A display device includes a prism layer including a plurality of prisms on a surface thereof, a support layer facing with the prisms on the prism layer: a medium layer placed between the prism layer and the support layer, and including a first medium having a first refractive index and a second medium having a second refractive index, the first and second media being freely movable in the medium layer, and electrodes supplying a potential difference between the prism layer and the support layer.

### CROSS REFERENCE TO RELATED APPLICATION

This application is based upon and claims the benefit of priority from prior Japanese Patent Application No. 2006-177255 filed on Jun. 27, 2006, the entire contents of which are incorporated by reference herein.

### BACKGROUND OF THE INVENTION

1. Field of the Invention

This invention relates to a display device which has a reflective mode and a transmissive mode.

2. Description of the Related Art

Liquid crystal displays (LCD) can be extensively thinned compared with cathode ray tubes (CRT), and are popular as home-use displays, display devices of personal computers, display devices of lap-top computers, and so on. Further, the LCDs are widely used for mobile phones, digital cameras, video cameras, vehicle navigation units, and so on.

Displays are classified into backlit transmissive LCDs and luminescent displays (such as CRTs), and reflective LCDs which reflect light beams from an external source.

Backlit transmissive LCDs and luminescent display suffer from a problem that image qualities may extensively depend upon ambient light. In order to overcome the problem, backlit transmissive LCDs and luminescent display should have strong luminescence and high contrast ratios.

On the contrary, the reflective LCDs vary an amount of reflected light beams in accordance with the ambient light. In short, the brighter surrounding areas, the more visible images the reflective LCDs can offer.

The reflective LCDs are effective in bright surrounding areas while the transmissive LCDs are effective in dim surrounding areas. Semi-transmissive LCDs which have features of both the transmissive LCDs and the reflective LCDs are also available.

The semi-transmissive LCD is provided with a backlight on a rear surface of a liquid crystal layer, and a reflective layer partly placed between the liquid crystal layer and the backlight. The reflective layer reflects light beams arriving via the liquid crystal layer.

When the surrounding area is bright, external light beams will be reflected by the reflective layer. On the contrary, the surrounding area is dim, the semi-transmissive LCD displays images in a transmissive mode using the backlight.

With the semi-transmissive LCD, one pixel is divided into a reflective region and a transmissive region, of which dimensions are fixed. It is impossible to realize a complete transmissive mode or a complete reflective mode. In short, an amount of reflective light beams cannot be increased without enlarging the reflective region. Therefore, the semi-transmissive LCD cannot offer bright reflective images compared with a display device in which one pixel serve as a reflective region.

Further, since the transmissive region is limited to a part of the pixel, an amount of transmissive light beams from the backlight is reduced. Therefore, the semi-transmissive LCD is very difficult to offer bright images unless an output of the backlight is increased.

JP-A 2002-139729 (KOKAI) describes a display device, which has the reflective and transmissive modes by reflecting external light beams using a reflector constituted by prisms, and transmitting light from a backlight to an exterior. In this case, the transmissive mode is realized by turning on the backlight. However, it is very difficult for a reflective display device without a backlight to realize the transmissive mode.

Therefore, semi-transmissive LCDs are difficult to offer bright images in both of the reflective and transmissive modes.

This invention has been contemplated to overcome problems of the related, and to provide a display device which can easily select the reflective mode and the transmissive mode, and offer brighter images.

### BRIEF SUMMARY OF THE INVENTION

According to the invention, there is provided a display device includes a prism layer including a plurality of prisms on a surface thereof; a support layer facing with the prisms on the prism layer; a medium layer placed between the prism layer and the support layer, and including a first medium having a first refractive index and a second medium having a second refractive index, the first and second media being freely movable in the medium layer; and electrodes supplying a potential difference between the prism layer and the support layer.

### BRIEF DESCRIPTION OF THE DRAWINGS

Like or corresponding parts are denoted by like or corresponding reference numerals.

FIG. 1 is a block diagram showing the overall configuration of a liquid crystal display (called “LCD”) according to a first embodiment of the invention;

FIG. 2 is a cross section of a liquid crystal panel of the LCD in FIG. 1;

FIG. 3 is a perspective view of a reflection/transmission selector used to select a reflective mode and a transmissive mode;

FIG. 4 is a cross section of the reflection/transmission selector in the reflective mode;

FIG. 5 is a cross section of the reflection/transmission selector in the transmissive mode;

FIG. 6 schematically shows the principle of a transmissive process;

FIG. 7 schematically shows the principle of a reflective process;

FIG. 8 schematically shows how the reflective process is conducted;

FIG. 9 schematically shows how the transmissive process is conducted;

FIG. 10 schematically shows how backlight is transmitted from a rear surface of the LCD panel;

FIG. 11 is a cross section of the LCD panel in the transmissive mode;

FIG. 12 is a cross section of the LCD panel in the reflective mode;

FIG. 13 is a perspective view of a reflection/transmission selector having a two-tier structure;

FIG. 14 is a perspective view of a further reflection/transmission selector having the two-tier structure;

FIG. 15 schematically shows how the reflective or transmissive mode is selected using the reflection/transmission selector;

FIG. 16 is a block diagram showing the overall configuration of an image display device according to a second embodiment;

FIG. 17 is a cross section of an image display panel of the image display device of FIG. 16;

FIG. 18 is a cross section of a further image display panel of the image display device of FIG. 16;

FIG. 19 a cross section showing the operation of the image display panel of FIG. 16;

FIG. 20 is a perspective view of a prism sheet;

FIG. 21 is a top plan view of the prism sheet;

FIG. 22 is a cross section of an image display panel according to a further embodiment;

FIG. 23 is a further cross section of an image display panel according to a further embodiment;

FIG. 24 is a further cross section showing the operation of the image display panel according to a further embodiment;

FIG. 25 is a perspective view of a reflection/transmission selector for selecting a reflective mode and a transmissive mode according to a further embodiment;

FIG. 26 is a perspective view of a prism sheet according to a further embodiment;

FIG. 27 is a top plan view of the prism sheet according to a further embodiment;

FIG. 28 is a perspective view of a prism according to a further embodiment;

FIG. 29 is a perspective view a further prism according to a further embodiment;

FIG. 30 is a perspective view of a still further prism according to a further embodiment;

FIG. 31 is a cross section of a further prism according to a further embodiment;

FIG. 32 is a cross section of a semi-spherical prism according to a further embodiment;

FIG. 33 is a perspective view of a prism according to a further embodiment;

FIG. 34 schematically shows the arrangement of prism according to a further embodiment;

FIG. 35 schematically shows a further arrangement of the prism according to a further embodiment;

FIG. 36 is a cross section of the prism taken along line A-A′ or B-B′ in FIG. 35;

FIG. 37 is a cross section of the prism taken along line C-C′ or D-D′ in FIG. 35;

FIG. 38 is a perspective view of a prism according to a further embodiment; and

FIG. 39 is a side elevation of the prism in FIG. 38.

### DETAILED DESCRIPTION OF THE INVENTION

### First Embodiment

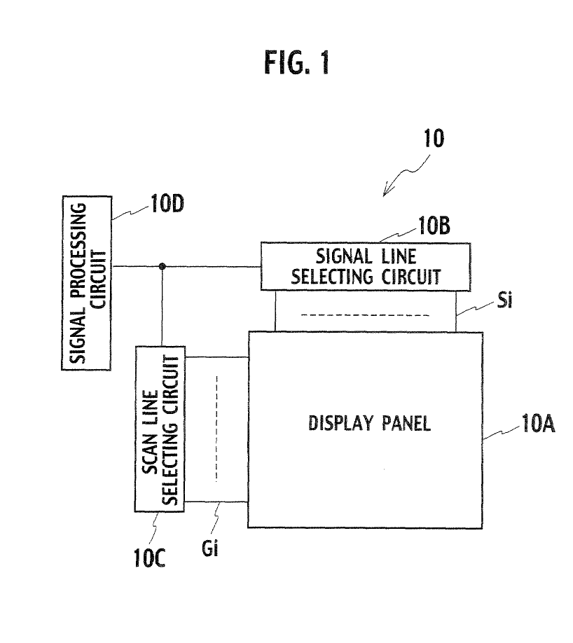

Referring to FIG. 1, a liquid crystal display device 10 (called the “LCD device 10”) includes a liquid crystal panel (display panel) 10A, in which a plurality of sub-pixels are arranged in the shape of a matrix. The sub-pixels correspond to cross points of signal lines Si and scanning lines Gi. The letter “i” denotes a positive integer. The signal lines Si are connected to a signal line selecting circuit 10B while the scanning lines Gi are connected to a scan line selecting circuit 10C. The signal line selecting circuit 10B and the scan line selecting circuit 10C are connected to a signal processing circuit 10D, which generates predetermined drive signals.

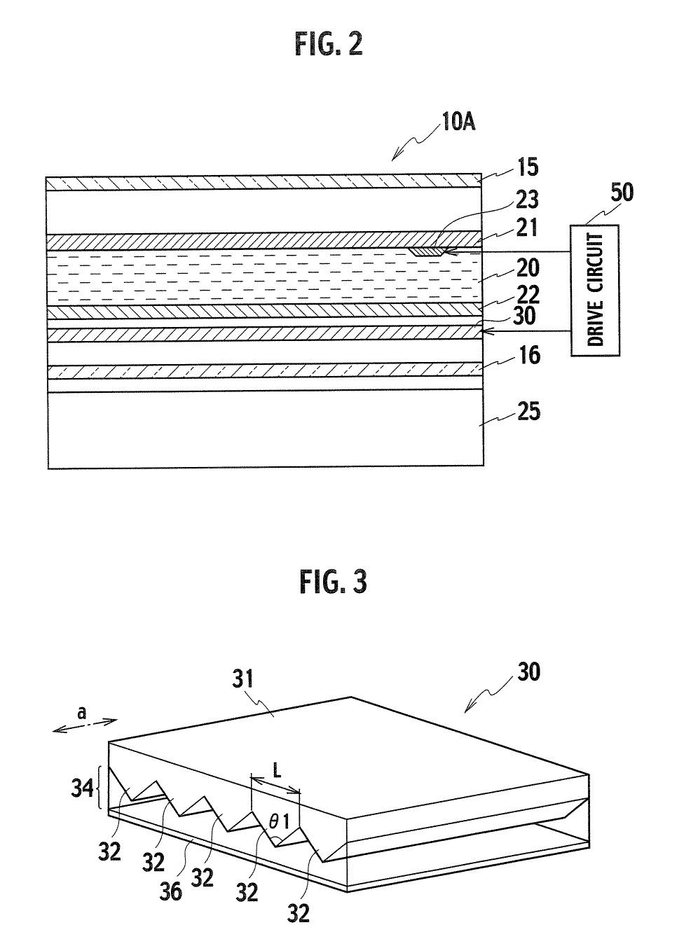

As shown in FIG. 2, the liquid crystal panel 10A includes a reflection/transmission selector 30 placed between a liquid crystal layer 20 and a backlight 25.

The liquid crystal layer 20 is placed between a pixel electrode 21 and a facing electrode 22. The electrodes 21 and 22 are made of ITO (indium-tin-oxide) or the like. The pixel electrode 21 is provided with a driving thin film transistor 23 (called the “TFT 23”). When the TFT 23 is activated by a drive signal from the signal processing circuit 10D, a voltage is applied to the liquid crystal layer 20 between the pixel electrode 21 and the facing electrode 22, so that an orientation of liquid crystal of the liquid crystal layer 20 can be changed.

The backlight 25 is placed on the rear side of the liquid crystal layer 20. In accordance with the orientation of the liquid crystal of the liquid crystal layer 20, light beams from the backlight 25 are transmitted to the front surface of the liquid crystal panel 10A via the liquid crystal layer 20. For the pixel, the signal processing circuit 10D provides a signal operating the backlight 25.

The liquid crystal layer 20 is provided with a first polarizer 15 on its front side and a second polarizer 16 on its rear side. Polarizing directions of the first and second polarizers 15 and 16 are displaced by 90 degrees. The orientation of the liquid crystal is varied in response to the voltage application to the liquid crystal layer 20. Light beams from the backlight 25 (in the transmissive mode) or light beams reflected by the reflection/transmission selector 30 (in the reflective mode) pass through the liquid crystal layer 20, and are blocked by the first polarizer 15. On the contrary, when no voltage is applied to the liquid crystal layer 20, the liquid crystal is oriented as predetermined. Light beams from the backlight 25 or light beams reflected by the reflection/transmission selector 30 are transmitted to the front surface of the liquid crystal panel 10A via the first polarizer 15. This is because the plane of polarization rotates in the liquid crystal layer 20 in accordance with the orientation of the liquid crystal.

In the liquid crystal layer 20 placed between the first and second polarizers 15 and 16, light beams from the backlight 25 or light beams reflected by the reflection/transmission selector 30 can be blocked or transmitted depending upon the application or non-application of the voltage.

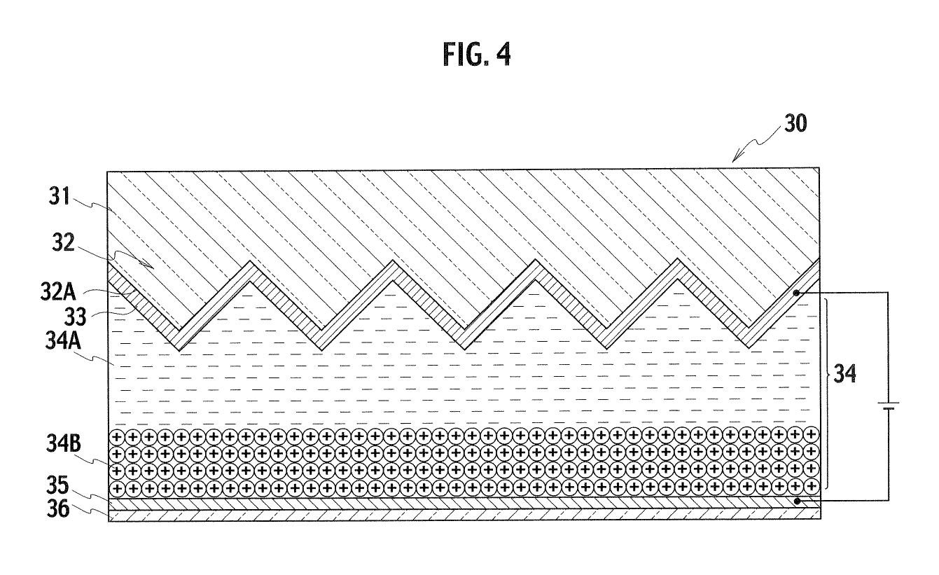

Referring to FIG. 3 and FIG. 4, the reflection/transmission selector 30 is placed between the liquid crystal layer 20 and the backlight 25, and includes a prism sheet 31 (prism layer), a transparent support 36 (support layer), a fine particle dispersing layer 34 (medium layer), and transparent electrodes 33 and 35. The prism sheet 31 has a plurality of prisms on its one surface, and a smooth surface on the surface thereof. The fine particle dispersing layer 34 includes an insulating solvent 34A (first medium), and fine resin particles 34B (second medium) which are freely movable therein. The insulating solvent 34A has a refractive index n₁ while the fine resin particles 34B has a refractive index n₂. Further, the insulating solvent 34A and the fine resin particles 34B are charged in opposite polarities. The transparent electrodes 33 and 35 cause a potential difference between the prism layer and the support layer.

The reflection/transmission selector 30 is controlled to select either the transmissive mode or the reflective mode in response to a changeover signal from a controller (not shown) in the signal processing circuit 10D.

The prisms 32 extend in the same direction “a” as shown in FIG. 3. Each prism 32 has an base distance L of 30 μm to 500 μm long, and has an apex angle θ1 of 90 degrees. The prisms 32 are made on one surface of the prism sheet 31 by a shaving or embossing process.

Referring to FIG. 4, the reflection/transmission selector 30 is constituted by the prism sheet 31, transparent electrode 33 on prism faces 32A of the prisms 32, fine particle dispersing layer 34, transparent electrode 35 facing with the transparent electrode 33, and transparent support 36 having the transparent electrode 35 on its one surface.

The transparent electrodes 33 and 35 are made of ITO, and are deposited on the prism faces 32A and the transparent support 36.

The fine particle dispersing layer 34 is made of a resin and a charge controlling agent dispersed in the insulating solvent 34A. Weight concentration of a solid content is adjusted to several percents of the liquid content. The insulating solvent 34A may be ISOPYER (trade name) manufactured by Exxon Corporation. The fine resin particles 34B is made of an acrylic resin or a styrene resin, and has a diameter of approximately 0.01 μm to μ5 m. The fine resin particles 34B in an amount of several weight % of the liquid and a metal soap made of zirconium naphthene or like in an amount of 10 weight % of the resin component are mixed in the insulating solvent 34A, and are dispersed using ultrasonic waves or the like. In this case, the fine resin particles 34B are positively charged. A voltage is applied between the transparent electrode 33 and the transparent electrode 35 in order that the transparent electrode 33 becomes positive. Therefore, the fine resin particles 34B are attracted to the transparent support 36. Further, the insulating solvent 34A is brought into contact with the prism sheet 31.

It is assumed here that the insulating solvent 34A may be ISOPYER (trade name) manufactured by Exxon Corporation, and has the refractive index n₁ which is approximately 1.40 to 1.43. Further, when the prism sheet 31 is constituted by glass whose refractive index n₀ is approximately 2.0, that is means the refractive index n₀ is larger than the refractive index n₁, i.e., n₁<<n₀. Therefore, a total internal reflective mode can be realized between the prism sheet 31 and the fine particle dispersing layer 34 (i.e., the insulating solvent 34A).

Alternatively, the insulating solvent 34A may be Fluorinert (trade name, and manufactured by 3M Corporation). Some Fluorinert has a smallest refractive index of approximately 1.24. The prism sheet 31 having a refractive index of approximately 1.75 can realize the total internal reflective mode. Further, the prism sheet 31 may be made of a resin material.

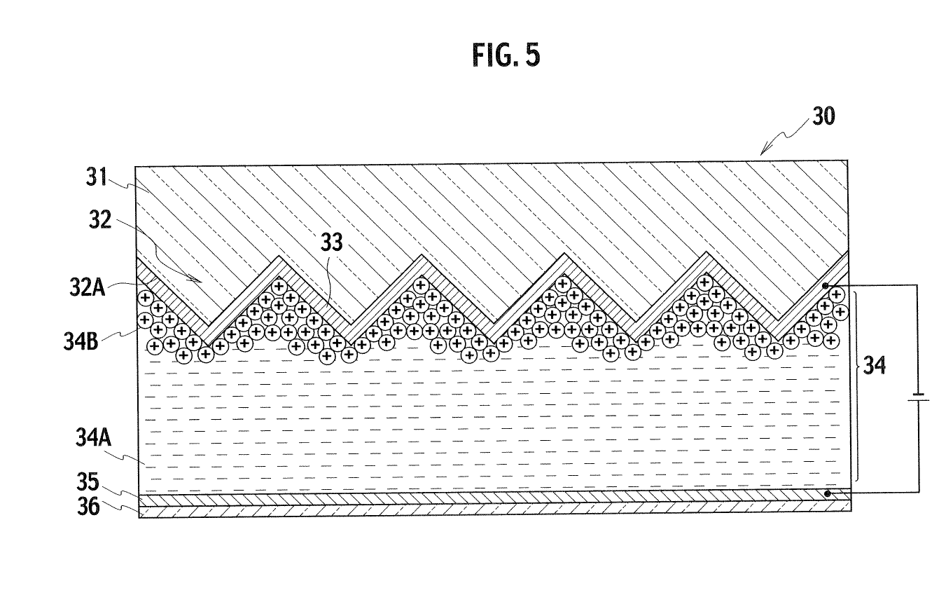

The voltage is applied between the transparent electrode 33 and 35 in order that the transparent electrode 35 becomes positive. Therefore, the fine resin particles 34B are attracted to the prism sheet 31. Further, the insulating solvent 34A is brought into contact with the transparent support 36 as shown in FIG. 5. The voltage application to the transparent electrodes 33 and 35 is conducted in response to the changeover signal from the control unit in the signal processing circuit 10D (shown in FIG. 1).

When the insulating solvent 34A is in contact with the transparent support 36, the refractive index n₂ of the fine resin particles 34B becomes approximately equal to n₀ of the prism sheet 31, so that n₀≈n₂. Therefore, a transmissive mode can be realized between the prism sheet 31 and the fine particle dispersing layer 34 (i.e., the fine resin particles 34B). A diameter of the fine resin particles 34B is equal to or smaller than 100 nm which is less than a wavelength of light. This is effective in suppressing diffused reflection of light beams.

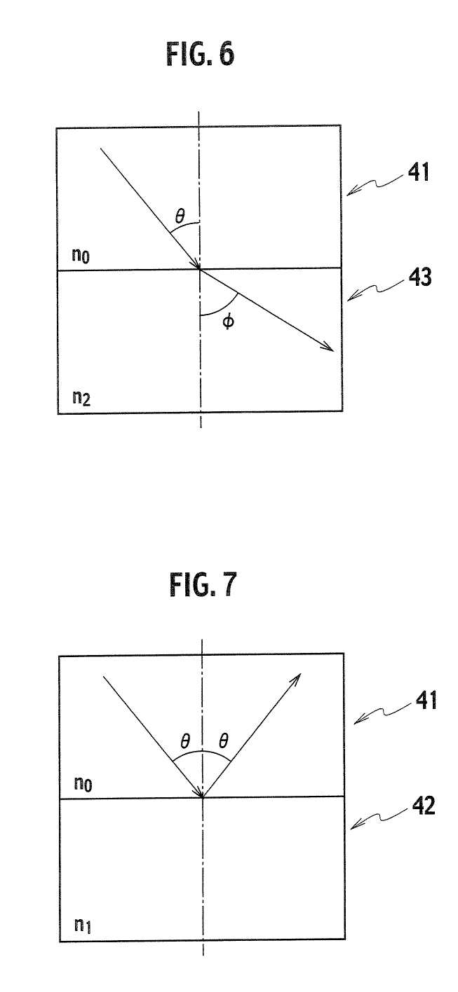

The principles of the reflective mode and the transmissive mode will be described with reference to FIG. 6 and FIG. 7. It is assumed that a first transparent medium 41 having the refractive index n₀ and a second transparent medium 42 having the refractive index n₁ or a third transparent medium 43 having the reflective index n₂ are in contact with one another. Further, it is assumed that n₀>n₂>n₁. The media 41, 42 and 43 are transparent, and transmit light beams. At a contact area of the first and second media 41 and 42 having the different refractive indices, or at a contact area of the first and third media 41 and 43 having different refractive indices, light beams are refracted in accordance with the Snell's law.

When the first and third media 41 and 43 are in contact with each other as shown in FIG. 6, the refractive index n₂ of the third medium 43 is smaller than the refractive index n₀ of the first medium 41 (i.e., n₀>n₂). Light beams arrive at the third medium 43 from the first medium 41 with an incident angle θ, and are refracted by a refractive angle φ which is larger than the incident angle θ. The refractive indices and the incident angles are related to be sin θ/sin φ=n₂/n₀. As the refractive index n₂ becomes further smaller, the refractive angle φ becomes 90 degrees. Therefore, no light beams can be incident in the third medium 43. In other words, when the refractive index is equal to or less than “n” (n=n₀×sin θ), light beams are total internal reflected. The refractive index n₁ of the second transparent medium 42 is equal to or less than “n” (n=n₀×sin θ), so that light beams arrive at the border between the first and second media 41 and 42 with the incident angle of θ, and are total internal reflected into the first medium 41 with a reflective angle which is equal to the incident angle θ.

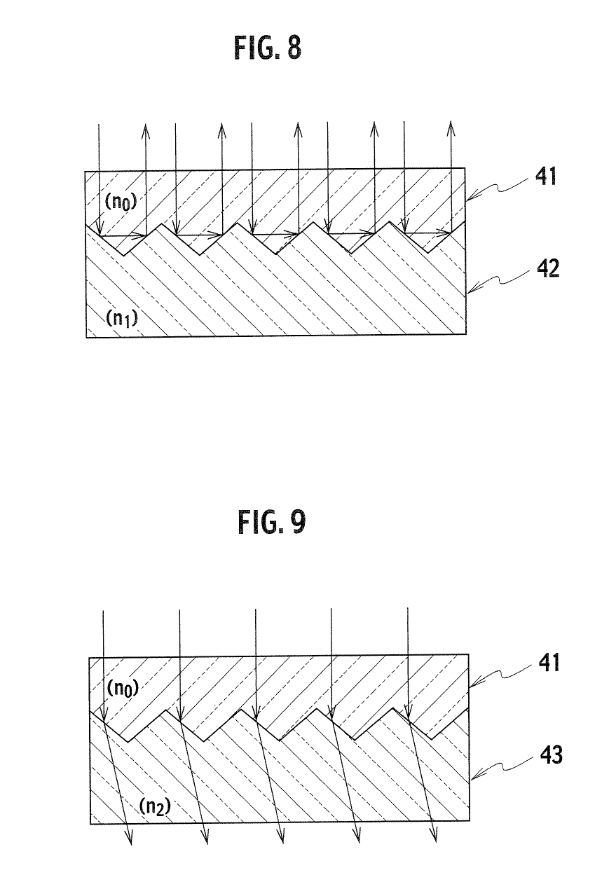

Referring to FIG. 8, the first medium 41 constituting a prism array and having the refractive index n₀ is in contact with the second medium 42 having refractive index n₁. When n₀>n₁ and when n₁ is small enough to meet the requirements for the total internal reflection, vertically incident light beams are total internal reflected and are returned to their origin. On the contrary, when the first medium 41 having the refractive index n₀ is in contact with the third medium 43 having refractive index n₂, the refractive indices are n₀>n₂. The refractive index n₂ does not meet the total internal reflection requirement (n₀≈n₂). Therefore, all of the light beams are refracted but advance to the third medium 43.

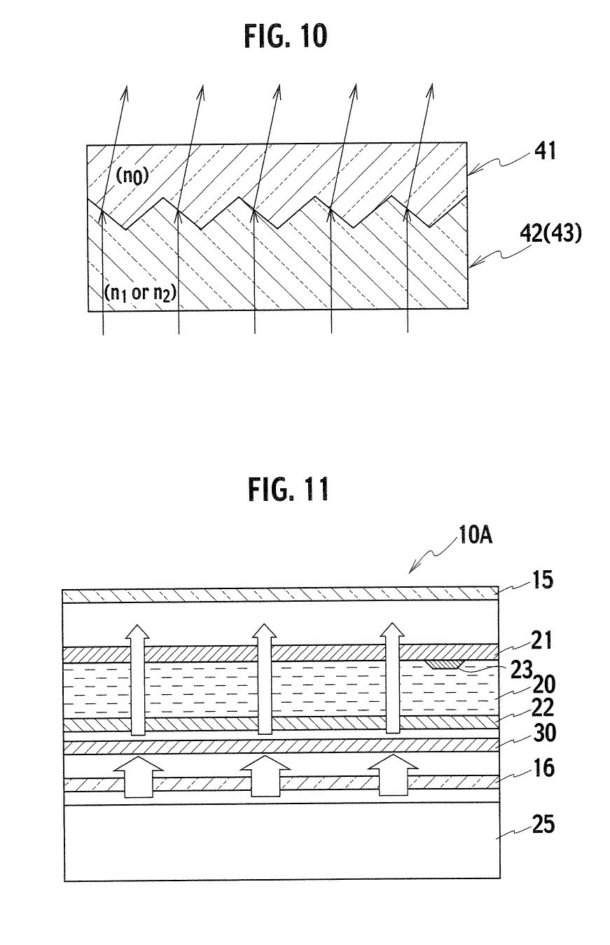

When the light beams are incident into the second medium 42 or third medium 43 in contact with the first medium 41 as shown in FIG. 10, the refractive indices are n₀>n₂>n₁. The incident light beams are refracted at the border between the first medium 41 and the second or third medium 42 or 43, but advance to the first medium 41 (i.e., the prisms).

All of the light beams can be reflected by bringing the second medium 42 (having the refractive index n₁) into contact with the first medium 41 (having the refractive index n₀). On the contrary, the light beams are not reflected by bringing the third medium 43 (having the refractive index n₂) into contact with the first medium 41, but are transmitted through the first and third medium 41 and 43. In short, the reflection/transmission selector 30 (shown in FIG. 4 and FIG. 5) is designed to select the refractive index of the medium (42 or 43) to be in contact with the first medium 41 in order to either reflect or transmit the light beams.

In this embodiment, the second medium 42 is made of the insulating solvent 34A (shown in FIG. 4 and FIG. 5), in which the fine resin particles 34B (as the third medium 43) in the amount of approximately several weight % are mixed. This enables the fine resin particles 34B to be mixed and to freely float in the insulating solvent 34A.

The fine resin particles 34B are freely movable in the insulating solvent 34A. When a voltage is applied between the transparent electrodes 33 and 35, positively charged fine resin particles 34B are attracted to the prism sheet 31 or the transparent support 36.

The insulating solvent 34A and the fine resin particles 34B have the different refractive indices. When the insulating solvent 34A is in contact with the prism sheet 31, a large difference between the refractive indices n₀ and n₁ enables the light beams arriving via the prism sheet 31 to be total internal reflected on the border between the prism sheet 31 and the insulating solvent 34A. Therefore, the light beams reflected on the border are transmitted via the prism sheet 31. On the contrary, when the fine resin particles 34B are in contact with the prism sheet 31, the light beams arriving via the prism sheet 31 are transmitted to the fine resin particles 34B via the border between the prism sheet 31 and the fine resin particles 34B.

The fine resin particles 34B are made of acrylic or styrene resins. Alternatively, they may be made of any resins, which have refractive indices larger than the refractive index of the insulating solvent 34A, and meet the requirement for not total internal reflecting any light beams. Any resin will do since they satisfy the foregoing requirements.

In the liquid crystal panel 10A of the LCD device 10, the reflection/transmission selector 30 is used to select the reflection mode or the transmission mode.

The reflection/transmission selector 30 is placed between the liquid crystal layer 20 and the backlight 25 as shown in FIG. 2. In the related art, a reflector is placed between a liquid crystal layer and a backlight in a liquid crystal panel.

In the related art, the reflector does not enable the passage of the light beams from the backlight. Therefore, when fabricating the liquid crystal panel having the transmissive and reflective modes, it is difficult to place the reflector all over one pixel. As a result, one pixel has a reflective region and a transmissive region. The reflective region is realized by the reflector while the transmissive region does not have a reflector, and transmits light beams. On the contrary, in this embodiment, the reflection/transmission selector 30 selects the reflection mode or the transmission mode in order to total internal reflect the light beams or transmit them. Therefore, all region of one pixel can serve both as the reflective region and the transmissive region.

It is assumed that the LCD device 10 is used in a dim surrounding. The reflection/transmission selector 30 controls a polarity of the voltage to be applied to the transparent electrodes 33 and 35, and selects the transmissive mode in which the fine resin particles 34B are attracted to the prism sheet 31. Refer to FIG. 5. In this state, the light beams from the backlight 25 can be transmitted to the front surface of the liquid crystal panel 10A by the operation of the reflection/transmission selector 30. Therefore, bright images can be offered with the assistance of the backlight 23.

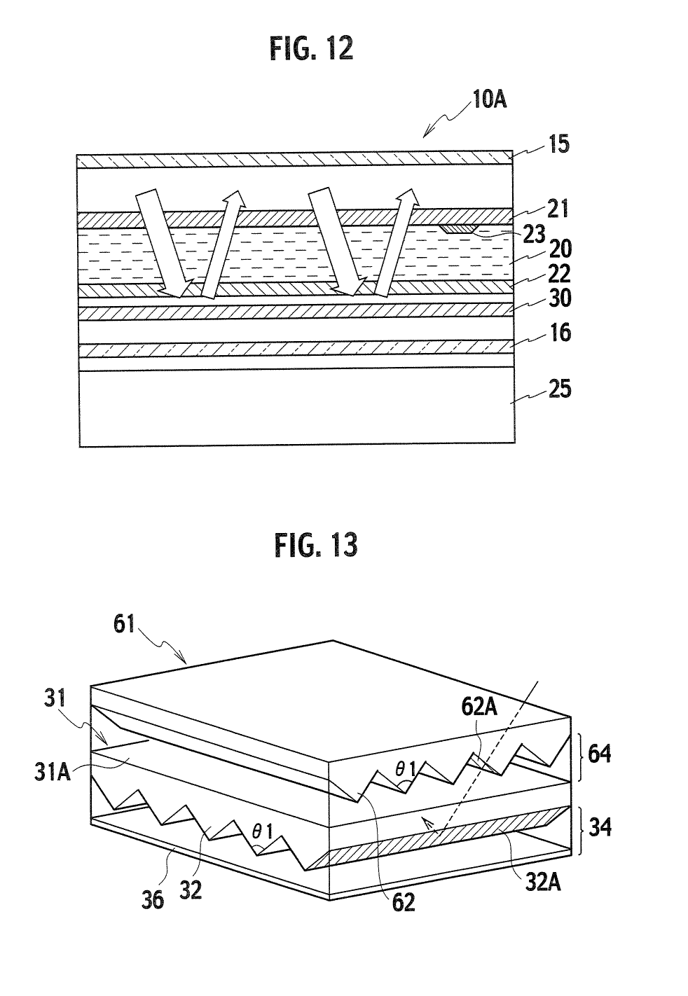

Conversely, it is assumed that the LCD device 10 is used in a bright surrounding. The reflection/transmission selector 30 reverses the polarity of the voltage to the transparent electrodes 33 and 35, and selects the reflective mode in which the fine resin particles 34B leave from the prism sheet 31 and are attracted to the transparent support 36. In this state, sufficient light beams arrive via the front surface of the liquid crystal panel 10A, and are reflected in response to the operation of the reflection/transmission selector 30. Refer to FIG. 12. Therefore, bright images can be offered using external light beams.

When the prism sheet 31 is in contact with the insulating solvent 34A or the fine resin particles 34B in the reflection/transmission selector 30, light beams from the fine particle dispersing layer 34 pass through its border with the prism sheet 31. In this state, the backlight 25 is turned on, and the reflection/transmission selector 30 is put in the reflective mode. Light beams from the backlight 25 assist light beams reflected in the reflective mode.

The liquid crystal panel 10A is selectively operated in the reflective mode or the transmissive mode by the operation of the reflection/transmission selector 30. Therefore, bright images can be offered in both the reflective and transmissive modes compared with those offered in the related art in which one pixel is partly used as the reflective region.

In the related art, when light beams are illuminated onto a rear side of a prism sheet and are transmitted to a front side, images will be darkened. With the LCD device 10 in this embodiment, the transmissive mode is selected using the reflection/transmission selector 30, so that bright images will be offered.

In this embodiment, one prism sheet 31 and one fine particle dispersing layer 34 are provided. Alternatively, quantities of these members may be plural.

Referring to FIG. 13, the first fine particle dispersing layer 34 is placed between the first prism sheet 31 and the transparent support 36. A second prism sheet 61 is provided with a space over the smooth surface of the first prism sheet 31. A second fine particle dispersing layer 64 is inserted between the second prism sheet 61 and the first prism sheet 31. The second prism sheet 61 has on its surface prisms 62, which face with the smooth surface 31A of the prism sheet 31.

Transparent electrodes made of ITO or the like are placed on the smooth surface 31A of the prism sheet 31 and on prism faces 62A of the prisms 62 of the second prism sheet 62. Therefore, a voltage is applied between the smooth surface 31A of the first prism sheet 31 and the prism faces 62a of the second prism sheet 61.

The second fine particle dispersing layer 64 is similar to the first fine particle dispersing layer 34, and is made of an insulating solvent in which fine resin particles are dispersed. When a voltage is applied to the transparent electrode on the first prism sheet 31 and the transparent electrode on the second prism sheet 61, the fine particles in the insulating solvent can be moved toward the first prism sheet 31 or the second prism sheet 61. This enables the selection of the reflective mode or the transmissive mode for the two prism sheets 31 and 61, respectively.

The reflective and transmissive modes can be selected for the two prism sheets 31 and 61, respectively. This is effective in offering reliable images even if they are observed from different directions, compared in the case where only one prism sheet is provided.

When a large display screen is used, one image may be differently observed in the reflective mode depending upon a view angle or a direction in which the image is observed. In such a case, if the image is observed in a direction which is orthogonal with the prism face 62A (shown by diagonal lines in FIG. 13), light beams will pass through the prism face 62A. When the two prism sheets 31 and 61 are used as shown in FIG. 13, light beams passing through the prism face 62A of the second prism sheet 61 are reflected by the prism face 32A (shown by diagonal lines) of the first prism sheet 31. With the LCD panel having the two prism sheets 31 and 61, the light beams are reflected in the reflective mode regardless of directions in which the image is observed. Further, the light beams can be reliably transmitted in the transmissive mode. Therefore, it is possible to reliably select the reflective mode or the transmissive mode even with the large display screen.

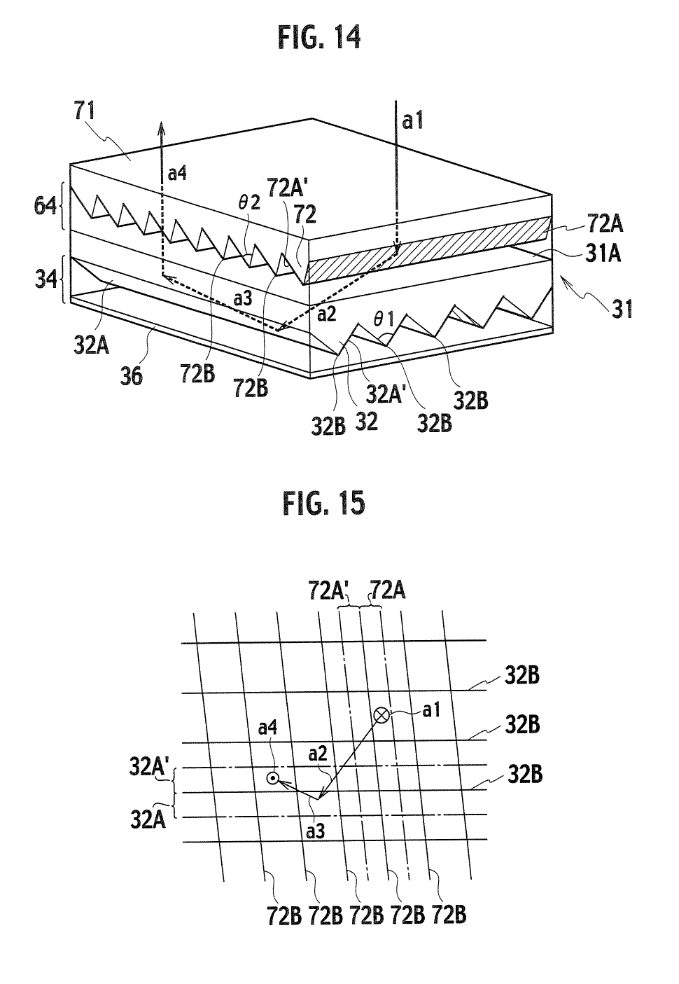

A further example of the two-tier structure is shown in FIG. 14. A second prism sheet 71 is placed over the smooth surface 31A of the first prism sheet 31 with a space maintained. The second fine particle dispersing layer 64 is placed between the first prism sheet 31 and the second prism sheet 71. The second prism sheet 71 has a plurality of prisms 72 on its one surface. The prisms 72 face with the smooth surface 31A of the first prism sheet 31.

Transparent electrodes made of ITO or the like are provided on the smooth surface 31A of the first prism sheet 31 and the prism face 72A of the second prism sheet 71. A voltage is applied between the smooth surface 31A and prism faces 72A.

The second fine particle dispersing layer 64 is similar to the first fine particle dispersing layer 34. In response to a polarity of the voltage applied between the transparent electrodes on the first and second prism sheets 31 and 71, fine particles in the insulating solvent can be moved toward the first or second prism sheet 31 or 71. Therefore, the LCD panel can be set to either the reflective or transmissive mode.

The apex angle θ1 of each prism 32 is 90 degrees while an apex angle θ2 of each prism 72 is 60 degrees. When the apex angle θ2 is smaller than the apex angle θ1, light beams a1 arriving at the second prism sheet 71 via the smooth surface thereof are incident onto the prism faces 72A of the prism 72 with a large angle, and can be total internal reflected. This means that the refractive index of the resin material used to make the prisms 72 (the prism sheet 71) can be reduced.

For instance, it is assumed that the apex angle θ2 is 60 degrees, and that the insulating solvent of the fine particle dispersing layer 64 has the refractive index 1.24. In this case, the light beams will be completely reflected so long as the prisms 72 have the refractive index of 1.43 or larger. On the contrary, if the insulating solvent of the fine particle dispersing layer 64 has the refractive index of 1.24 and the apex angle θ2 is 90 degrees, the refractive index of the prisms 72 should be 1.75 or larger in order to total internal reflect the light beams. As long as the resin material for the prisms 72 has the small refractive index, a number of usable resin materials are available.

Referring to FIG. 14, light beams a2 are total internal reflected on the prism faces 72A of the prisms 72 are incident onto the prism faces 72A′ with a small angle, and pass there.

The light beams a2 passing through the prism faces 72A′ are incident onto the first prism sheet 31 via the smooth surface 31A.

The light beams arrive at the prism faces 32A of the prism sheet 31 with a large incident angle compared with light beams arriving at the prism sheet 31 in a direction orthogonal to the prism sheet 31. Therefore, the former light beams can be total internal reflected.

As shown in FIG. 15, the prism sheet 31 and the prism sheet 71 are arranged so that the prisms 32 and the prisms 72 are displaced by more than 90 degrees, i.e., the apexes 32B and apexes 72B of the prisms 32 and 72 are similarly displaced. Therefore, light beams a3 reflected on the prism faces 32A are incident onto prism faces 32A′ facing with the prism faces 32A with a large angle, are total internal reflected on the prism faces 32A′, and pass through the prism sheet 71 (as reflected light beams a4).

The two prism sheets 31 and 71 are stacked, and the apex angle θ2 of each prism 72 of the second prism sheet 71 is smaller than the apex angle θ1 of each prism 32 of the first prism sheet 31. It is possible to make the second prism sheet 72 using a resin material which has a refractive index of 1.43 or larger and is easily available.

### Second Embodiment

In the first embodiment, the two media having the different refractive indices are selectively used in order to operate the display device in the reflective or transmissive mode using the reflective/transmissive mode selector 30. The reflective/transmissive mode selector 30 is assembled in the LCD panel. Alternatively, the reflective/transmissive mode selector itself can be used to constitute a reflective image display device.

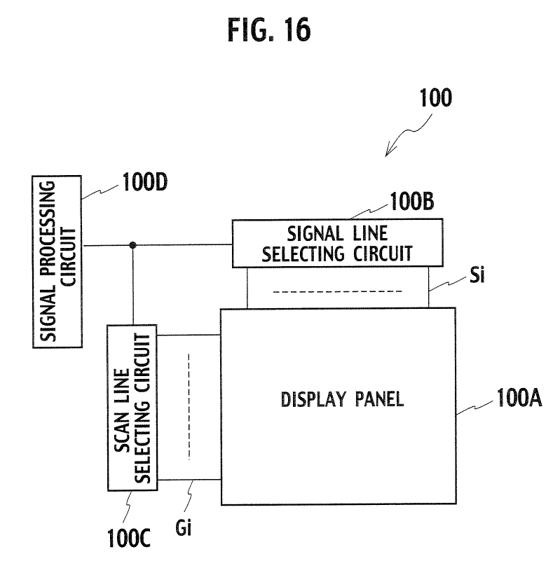

A display device 100 of a second embodiment is configured as shown in FIG. 16 to FIG. 21. Referring to FIG. 16, the display device 100 includes a display panel 100A, in which a plurality of sub-pixels are arranged in the shape of a matrix in order to correspond to cross points of signal lines Si (i being a positive integer) and scanning lines Gi. The signal lines Si are connected to a signal line selecting circuit 100B while the scan lines Gi are connected to a scan line selecting circuit 100C. Both of the signal line selecting circuit 100B and the scan line selecting circuit 100C are connected to a signal processing circuit 100D, which produces a predetermined drive signal.

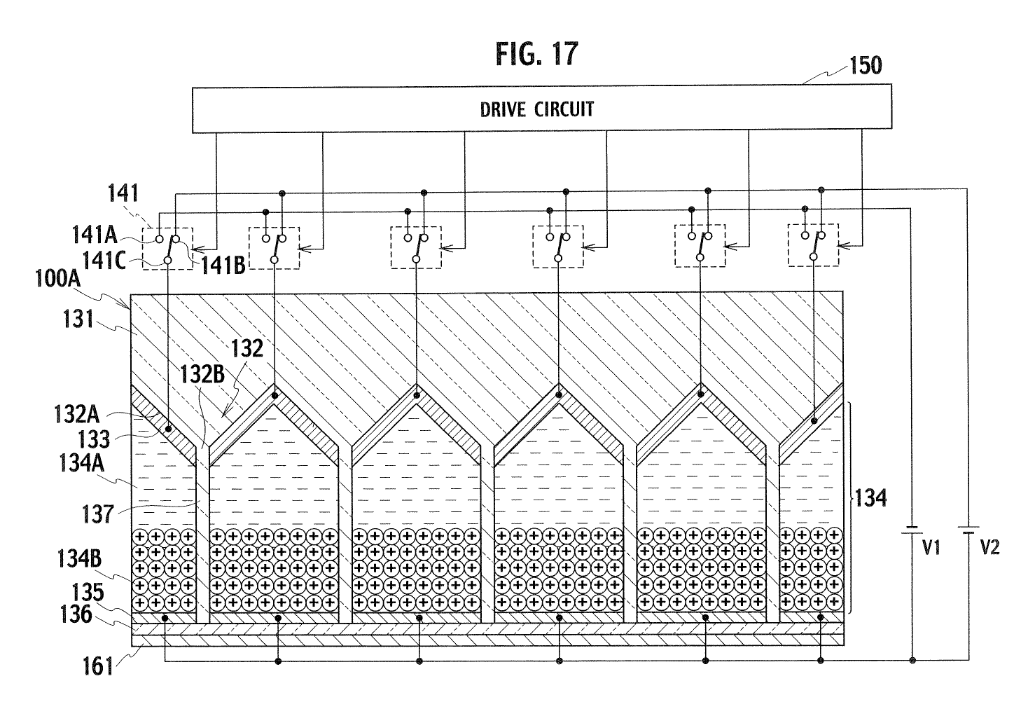

As shown in FIG. 17 to FIG. 19, the display panel 100A includes a fine particle dispersing layer 134 which is sandwiched between a prism sheet 131 and a transparent support 136. The prism sheet 131 includes a plurality of prisms 132 in the shape of a quadrilateral pyramid on a surface facing with the transparent support 136. The prisms 132 are two-dimensionally arranged as shown in FIG. 20. A bottom of each prism 132 has a size L which is equal to a size of one pixel.

Referring to FIG. 17 to FIG. 19, adjacent prisms 132 are separated by partitions 137, so that the fine particle dispersing layer 134 is split into a plurality of small cells. The partitions 137 are arranged in a reticular pattern so as to come across apexes 132B of the prisms 132 as shown in FIG. 21.

In the second embodiment, the partitions 137 are integral with the prism sheet 131. Alternatively, they may be integral with the transparent support 136.

In the display panel 100A, the fine particle dispersing layer 134 are split into small cells by the partitions 137. The small cells are two-dimensionally positioned.

As shown in FIG. 17 to FIG. 19, each small cell is displaced by ½ L for each prism 132. Alternatively, one small cell may be used for a plurality of prisms 132 if the size L of each prism 132 is small compared with a size of each small cell.

Each prism 132 has an apex angle of 90 degrees. Transparent electrodes 133 and 135 are placed on each prism face 132A of each prism 132 and on a surface of the transparent support 136. The transparent electrodes 133 and 135 are made by depositing the ITO.

An insulating solvent 134A for the fine particle dispersing layer 134 is similar to that used in the first embodiment. Fine acrylic or styrene resin particles (fine resin particles 134B) of several weight percents are dispersed in the insulating solvent 134A. Therefore, the fine resin particles 134B are freely movable in the small cells.

Each transparent electrode 133 of each small cell is connected to an output end 141C of each switching circuit 141. Each switching circuit 141 includes a first input end 141A and a second input end 141B, which are connected to power sources V1 and V2, respectively. The power sources V1 and V2 have different polarities. In each small cell, each transparent electrode 135 near the transparent support 136 is connected to the power sources V1 and V2. When each switching circuit 141 is operated, a voltage having a first polarity or a second polarity is selectively applied between transparent electrodes 133 and 135 of each small cell.

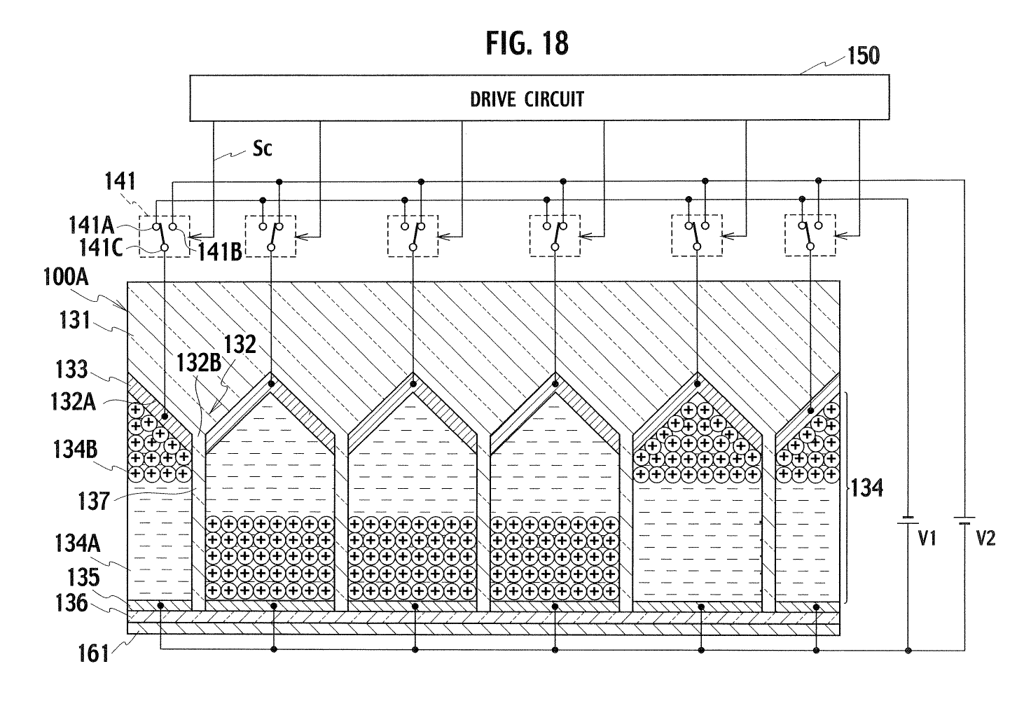

As shown in FIG. 18, in a small cell where the transparent electrode 133 is connected to the first input end 141A of the switching circuit 141, the transparent electrode 133 becomes negative. Therefore, fine resin particles 134B will be attracted to the transparent electrode 133. Conversely, in a small cell where the transparent electrode 133 is connected to the second input end 141B of the switching circuit 141, the transparent electrode 135 becomes negative, so that fine resin particles 134B will be attracted to the transparent electrode 135.

The insulating solvent 134A may be ISOPYER (trade name) manufactured by Exxon Corporation. A refractive index n₁ of the insulating solvent 134A is approximately 1.40 to 1.43. When the prism sheet 131 made of glass whose refractive index n₀ is approximately 2.0 is used, that is means the refractive index n₀ is larger than the refractive index n₁, i.e., n₁<<n₀. This enables the total internal reflection mode to be established between the prism sheet 131 and the fine particle dispersing layer 134 (insulating solvent 134A). Further, the fine resin particles 134B made of an acrylic or styrene resin have a refractive index n₂, which is close to the refractive index n₀ of the prism sheet 131, i.e., n₀≈n₂. Since a difference between the refractive indices of the prism sheet 131 and the fine resin particles 134B is covered in a range where the total internal reflection is not allowed. Therefore, the transmissive mode can be established between the prism sheet 131 and the fine particle dispersing layer 134 (fine resin particles 134A). Further, the fine resin particles 134B may be made of any resin which has the refractive index larger than that of the insulating solvent 134A and satisfies the requirement for not causing the total internal reflection. Generally speaking, resins have the refractive index larger than that of the insulating medium layer 134, so that any resin is usable.

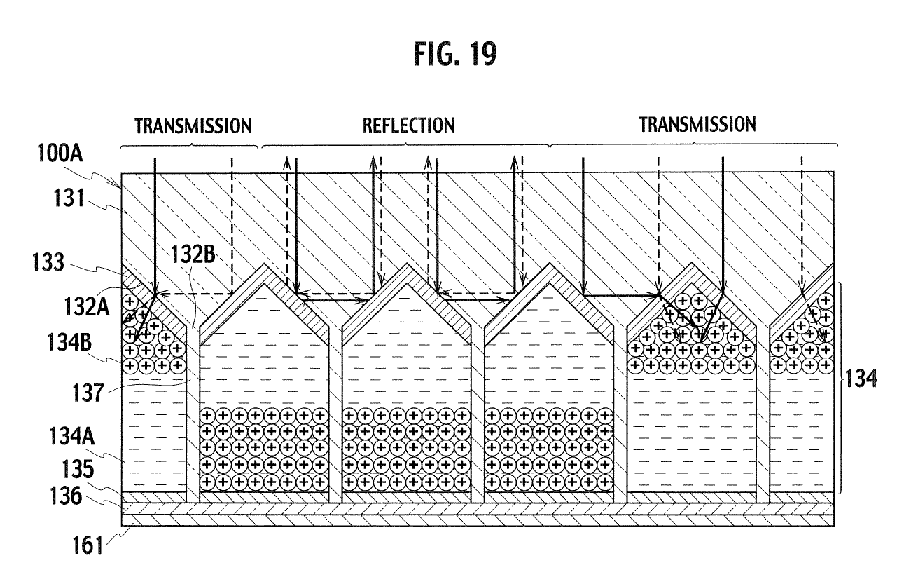

The switching circuits 141 are connected to a drive circuit 150. The drive circuit 150 supplies a control signal Sc to each switching circuit 141 related to each small cell of the display panel 100A in response to an image signal to be indicated on the display panel 100A. Therefore, each small cell is selectively set to the reflective mode or the transmissive mode in response to an image to be indicated on the display panel 100A as shown in FIG. 19. The drive circuit 150 includes the signal line selecting circuit 100B, scan line selecting circuit 100C, and signal processing circuit 100D.

A coloring layer 161 is placed on the rear surface of the transparent support 136 (which is opposite to the surface where the transparent electrode 135 is present). In small cells controlled to the transmissive mode, the coloring layer 161 is visible via a border between the prism sheet 131 and the fine particle dispersing layer 134. The small cells in which the coloring layer 161 is visible in the transmissive mode will be selected in accordance with the image to be shown. The transmissive mode is selected, and an image will be shown on the display panel 100A. It is assumed that adjacent small cells are set to the reflective mode as shown in FIG. 19. External light beams are reflected by prism faces 132A of the adjacent small cells, and are returned externally. On the contrary, in small cells which are set to the transmissive mode, external light beams pass through the prism faces 132A, so that the coloring layer 161 will be visible.

Moving images will be shown by varying voltage patterns to be applied to respective pixels and selecting the reflective mode or the transmissive mode in terms of time.

With the display device 100 of this embodiment, the fine particle dispersing layer 134 is placed between the prism sheet 131 and the transparent support 136. The fine particle dispersing layer 134 is split into a plurality of small cells by the partitions 137 in order to control polarities of voltages to be applied to the small cells. In small cells in the transmissive mode, the coloring layer 161 on the rear surface of the display panel 100A is visible. Therefore, the reflective type display device can be realized by controlling the transmissive mode for every small cell in accordance with an image to be displayed.

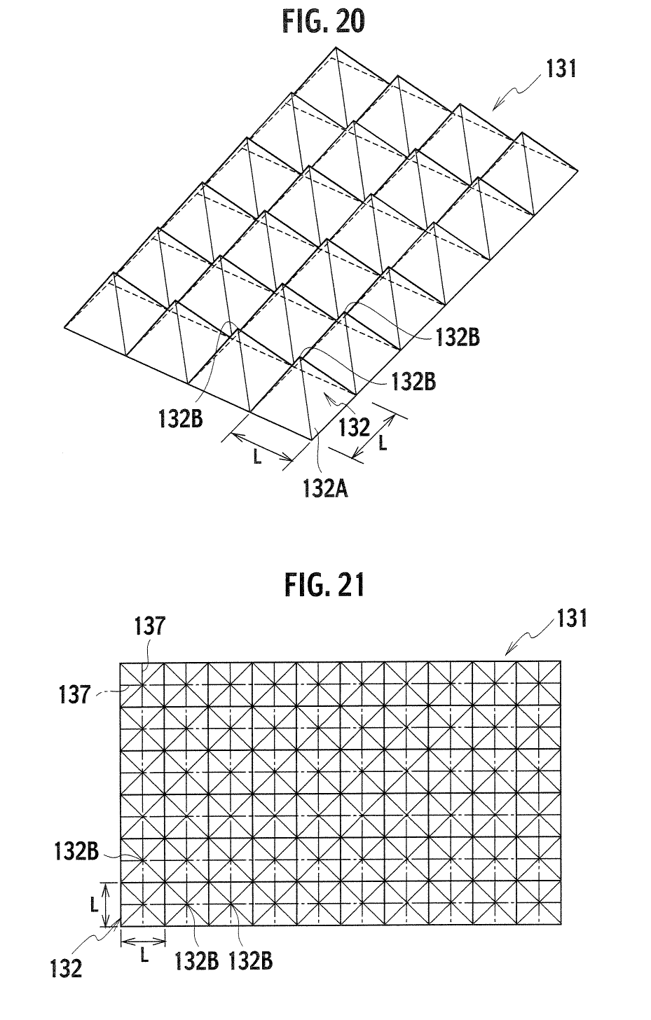

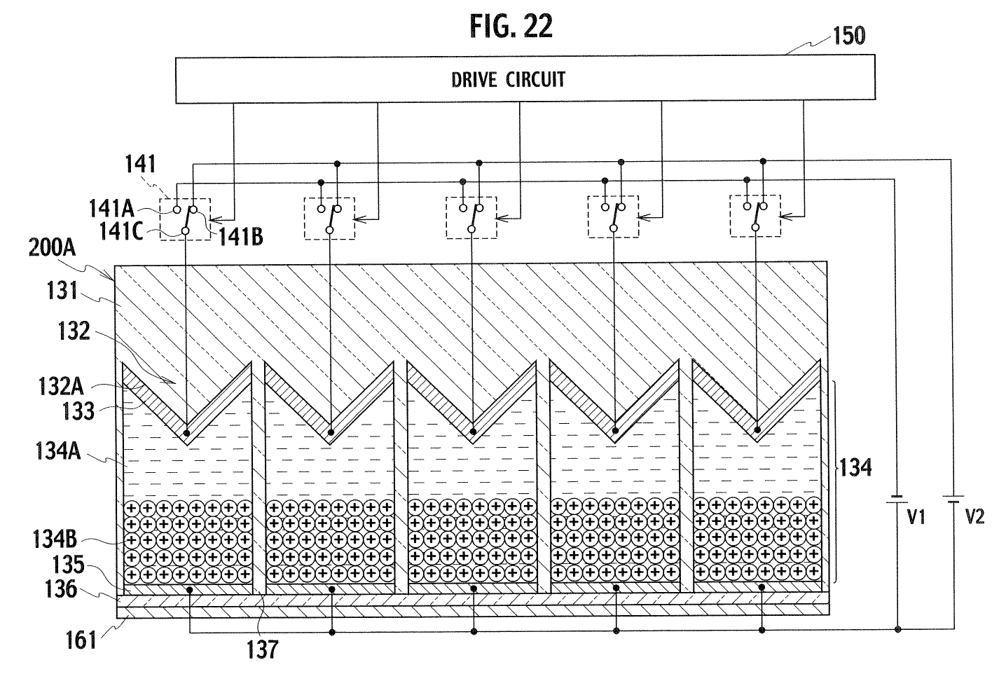

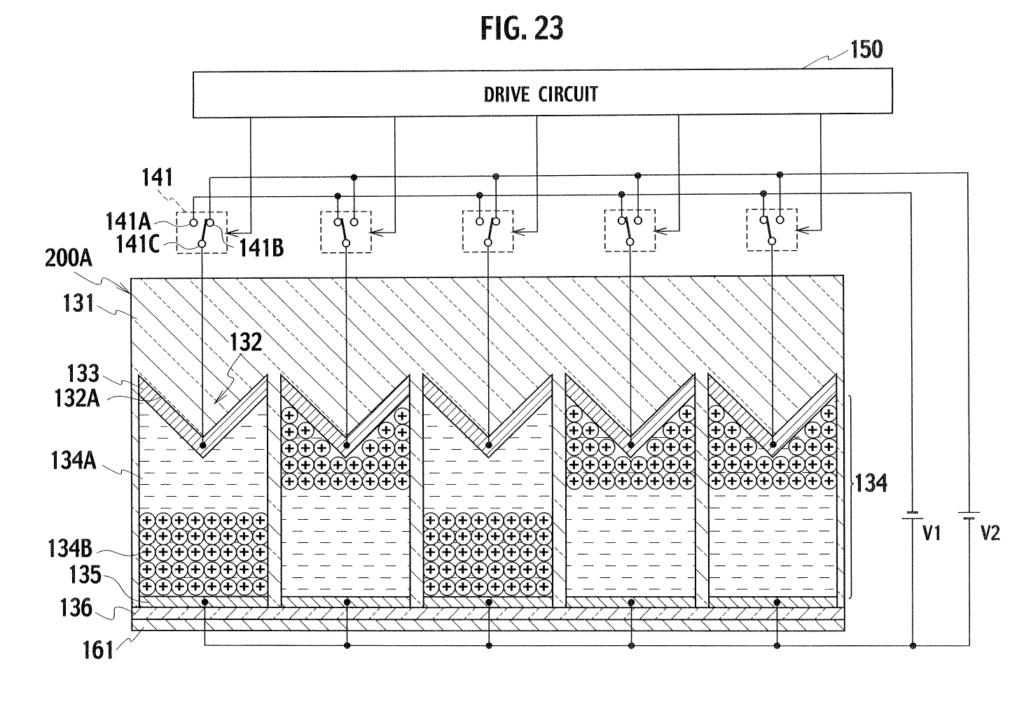

In the second embodiment, the partitions 137 are arranged in such a manner that they come across the apexes 132B of the prisms 132. Alternatively, the partitions 137 may be placed along bottoms of the prisms 132 on the prism sheet 131 as shown in FIG. 22 to FIG. 24.

A display panel 200A is structured as described above (refer to FIG. 22 to FIG. 24), but is similar to the display panel 100A (shown in FIG. 17 to FIG. 19) on the other respect.

In the display panel 200A, each small cell defined by each partition 137 is placed in front of each prism 132, and one prism 132 corresponds to one small cell. In other words, one prism 132 is in alignment with one small cell. Each prism 132 is inevitably out of alignment with each small cell in the display panel 100A shown in FIG. 19. Further, the number of pixels which are externally visible in the reflective mode in the display panel 100A is smaller by one than the number of small cells (refer to FIG. 19) while the number of pixels is larger by one than the number of small cells in the transmissive mode. In short, if three adjacent small cells are in the reflective mode as shown in FIG. 19, only two pixels are in the reflective mode when externally observed.

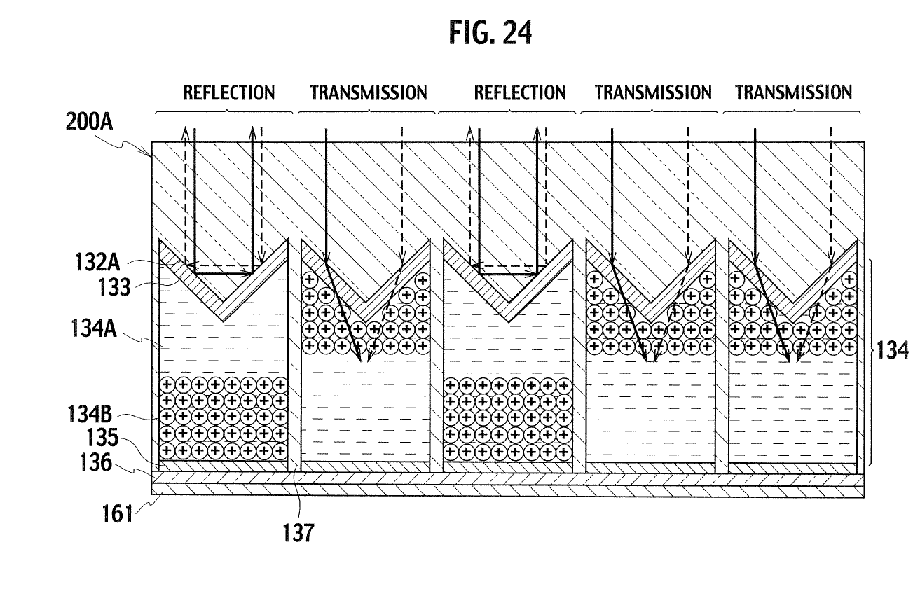

On the contrary, in the display panel 200A (shown in FIG. 22 to FIG. 24), one small cell and one prism 132 are present at the same position, so that the number and positions of the small cells agree with the number and positions of the pixels as shown in FIG. 24.

If each prism 132 is smaller than each small cell in the display panel 200A, partitions 137 may be placed so that one small cell serves for a plurality of prisms 132.

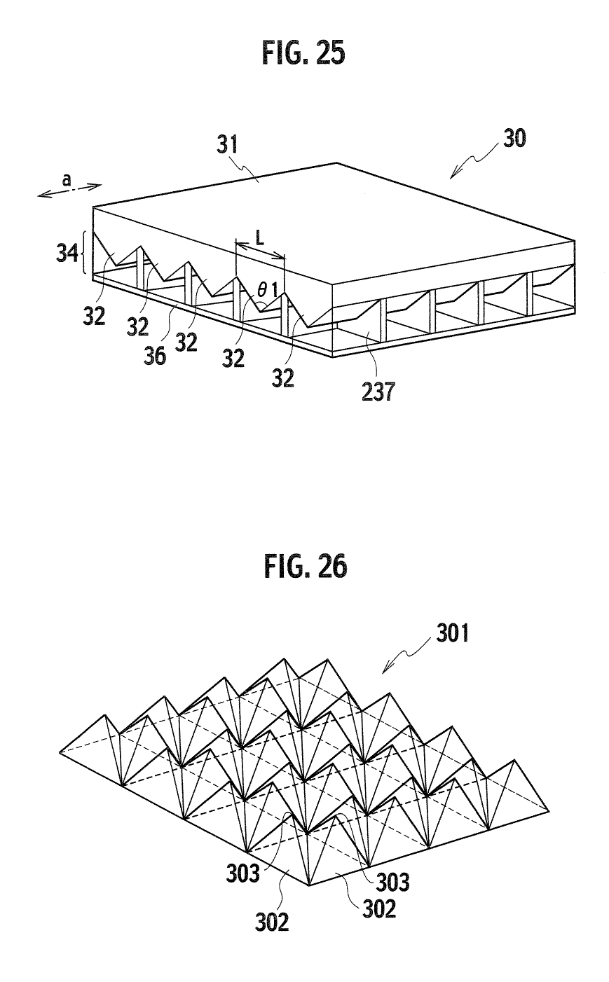

In the second embodiment, the prism sheet 131 includes the quadrilateral pyramidal prisms placed two-dimensionally. Alternatively, the prism sheet 31, 61 or 71 including prisms 32, 62 or 72 extending in one direction may be used as shown in FIG. 3. In such a case, as shown in FIG. 25, partitions 237 may be arranged so that they come across longer sides of the prisms 132. This enables a plurality of small cells to be made.

### Other Embodiments

In the first embodiment, the prisms 32 are arranged in one direction. Alternatively, the prisms 132 in the shape of a quadrilateral pyramid may be two-dimensionally arranged as shown in FIG. 20. In this case, the apex angle of the prisms is preferably 90 degrees. The use of the prisms 132 in the shape of the quadrilateral pyramid is advantageous in the following respects. Even when only one prism sheet including the quadrilateral pyramidal prisms 132 is used, it is possible to stave off an unstable state in which the reflective mode is occasionally changed to the transmissive mode depending upon an angle at which images are observed or depending upon a direction or an angle of field of view when a large display is observed.

In the first and second embodiments, the prism sheet 31 includes the prisms 32 arranged in parallel and in one direction (shown in FIG. 3), and the prism sheet 131 includes the quadrilateral pyramidal prisms 132 arranged two-dimensionally (shown in FIG. 20). Alternatively, prisms in any shapes are usable.

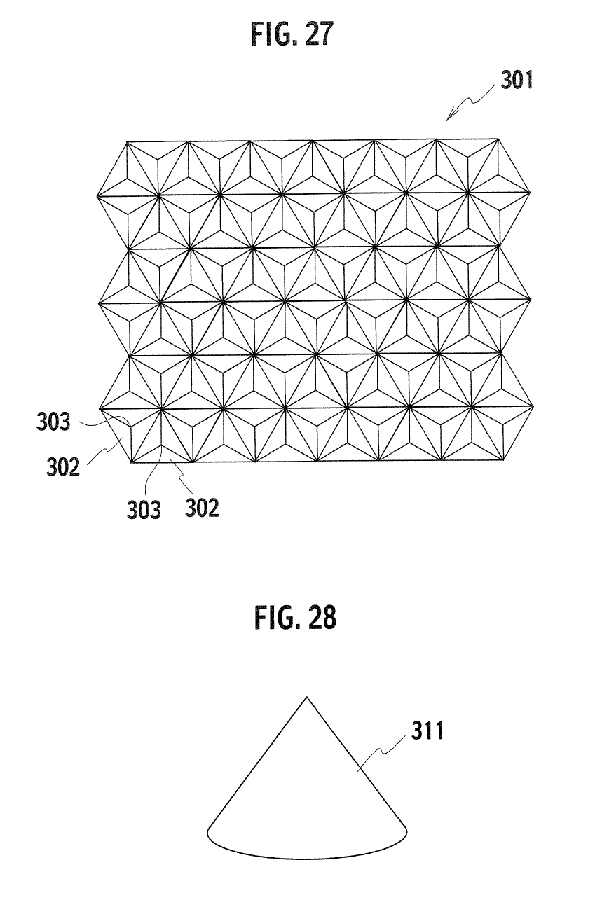

For instance, as shown in FIG. 26 and FIG. 27, a prism sheet 301 in which triangular pyramidal prisms 302 are two-dimensionally arranged may be used. In such a case, three prism faces which gather at an apex 303 preferably form 90 degrees. Since the prism sheet 301 is in the shape of a corner cube, light beams arriving at prisms 302 are reflected by prism faces and are returned to their origin. In the reflective mode, all of the light beams are reflected, so that the reflective mode can be maintained regardless of a direction in which images are observed, or regardless of an angle of field of view.

Further, cone prisms 311 shown in FIG. 28 may be usable. In this case, an apex angle is preferably 90 degrees. Still further, prisms may be in the shape of a six-sided pyramid, an eight-sided pyramid and so on which is between the quadrilateral pyramid and the cone.

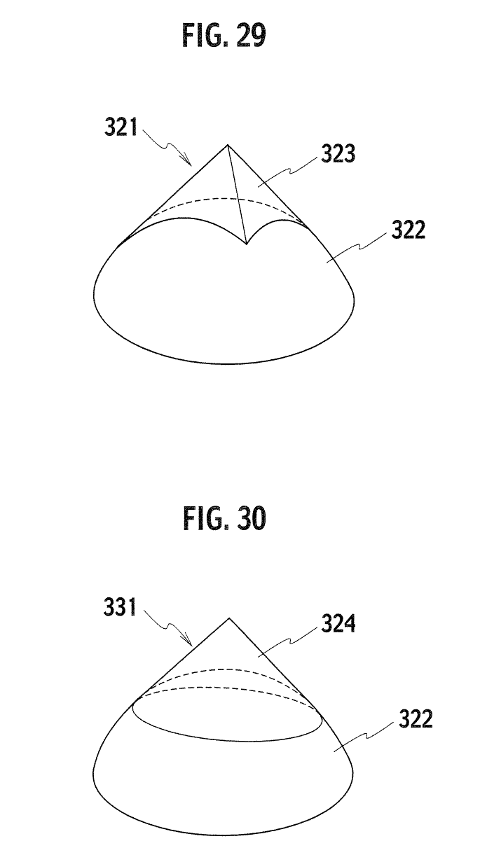

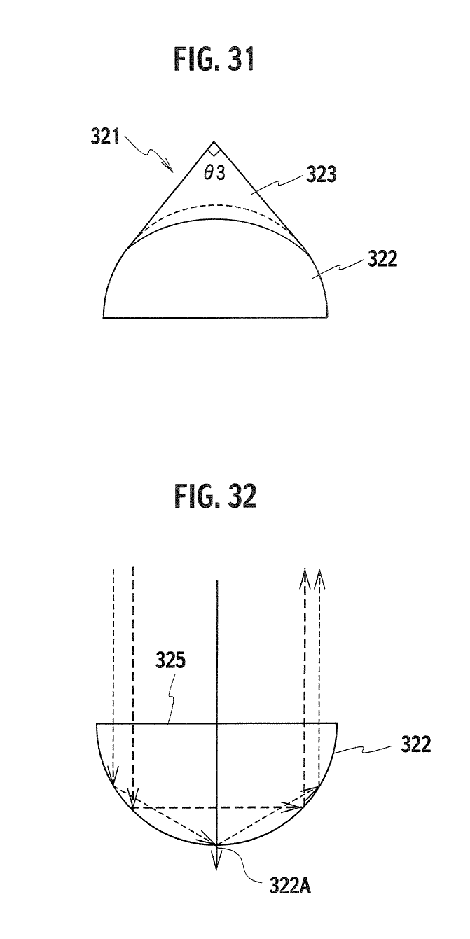

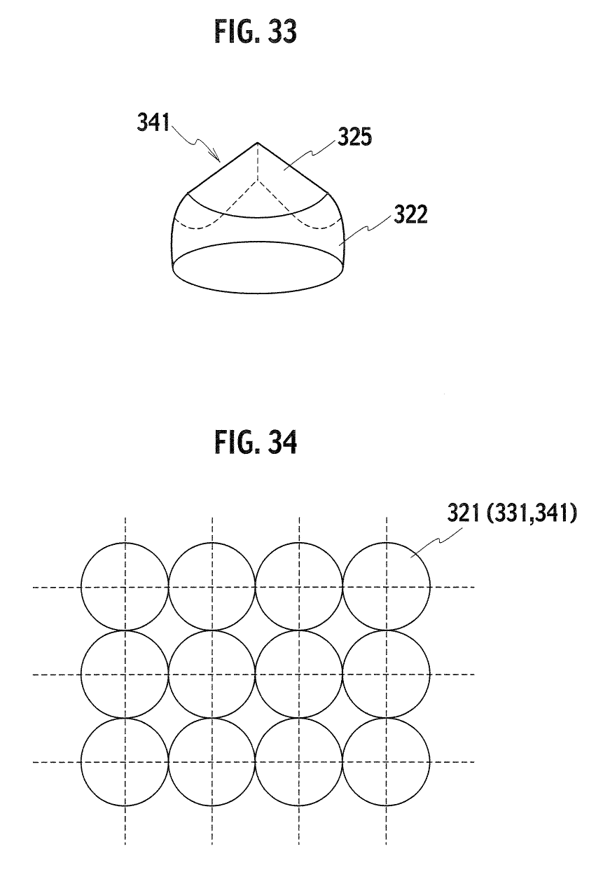

As shown in FIG. 29, a prism unit 321 may be in the shape of a combination of a hemispherical lens 322 and a quadrilateral pyramidal prism 323. Further, a prism unit 331 may be in the shape of a combination of the hemispherical lens 322 and a cone prism 324 as shown in FIG. 30. Referring to FIG. 31, the quadrilateral pyramidal prism 323 whose apex angle θ3 is 90 degrees is placed on the hemispherical lens 322. Light beams passing through the hemispherical lens 322 may be subject to the reflective mode by the quadrilateral pyramidal prism 323. It is assumed that light beams arrive at the hemispherical lens 322 via its flat bottom 325 as shown in FIG. 32. Light beams are incident near the bottom 325 at a large angle. If there is difference between refractive indices of the prism 323 and the hemispherical lens 322, light beams are total internal reflected and are returned to their origin. The farther the incident position of light beams, the smaller the incident angle. So long as the incident position is outside the apex angle 322A of the hemispherical lens 322 by a predetermined quantity, light beams are total internal reflected as shown by a dashed line, and return to their origin. On the contrary, light beams arrive via the center of the bottom 325, reach the apex 322A of the hemispherical lens 322, has a small incident angle, and pass through the hemispherical lens 322 as shown by a solid line. Light beams which reach within a certain range from the apex 322A pass through the hemispherical lens 322. Light beams outside the foregoing certain range will be reflected. A border between light beams which pass through the hemispherical lens 322 and light beams which are reflected depends upon a difference between a refractive index of a material of the hemispherical lens 322 and a refractive index of a medium around the hemispherical lens 322. As shown in FIG. 29, the quadrilateral pyramidal prism 323 is combined with the hemispherical lens 322 in order to enable the light beams passing through the apex 322A of the hemispherical lens 322 to be used for the reflective mode. This structure is effective in controlling light beams (which pass through the center of the hemispherical lens 322) to the reflective mode by the use of the quadrilateral pyramidal prism 323 as a whole of the prism unit 321. The combination of the hemispherical lens 322 and the cone prism 324 (shown in FIG. 30) is as effective as the foregoing combination. Further, as shown in FIG. 33, a prism unit 341 in which the hemispherical lens 322 is combined with a corner cube prism 325 is as effective as the combinations of the hemispherical lens 322 and the quadrilateral pyramidal prism 323 and the cone prism 324.

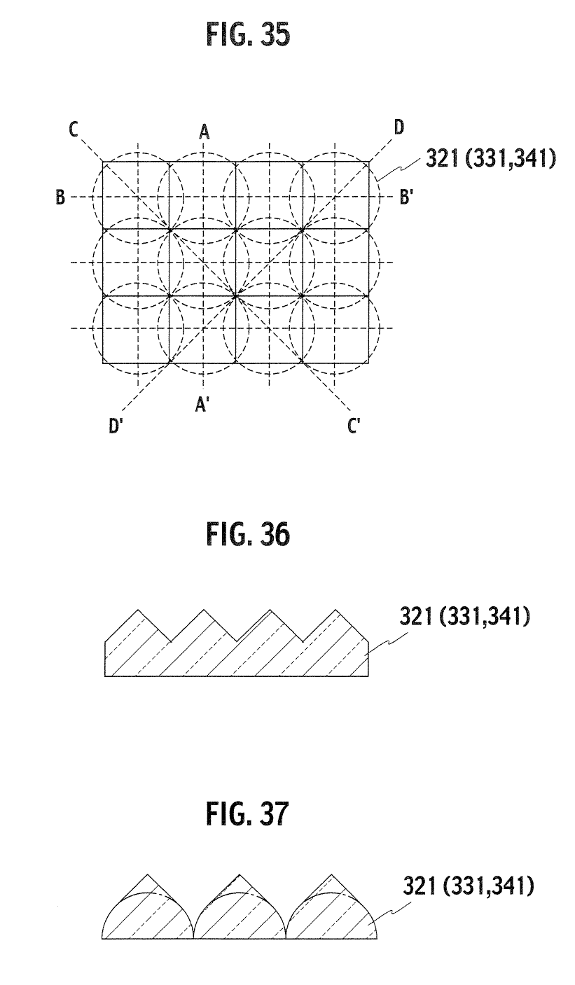

As shown in FIG. 34, when the prism units 321, 331 or 341 shown in FIG. 28 to FIG. 33 are two-dimensionally arranged with their circular bottoms in contact with one another, there will be spaces at positions where the circular bottoms are out of contact with one another. Light beams arriving at the spaces will always pass through the prisms, which makes it difficult to establish the reflective mode throughout the display screen. To overcome this problem, the prisms having circular bottoms are arranged in all directions so that peripheral edges of the circular bottoms will overlap and intersect diagonally as shown in FIG. 35. When observing the prisms in the directions C-C′ and D-D′ (shown in FIG. 35), the circular bottoms are in contact with one another. However, when observing the prisms in the direction A-A′ and B-B′ (shown in FIG. 35), the circular bottoms overlap. Therefore, the prism units 321 (331 or 341) are processed and arranged accordingly. FIG. 36 is a cross section of the prism units 321 (331 or 341) taken along line A-A′ (or B-B′), and shows that the prisms having the apex angles of 90 degrees are arranged. FIG. 37 is a cross section of the prisms 321 (331 or 341) taken along line C-C′ (or D-D′), and shows that the semispherical lenses and the prisms having the apex angles of 90 degrees are two-dimensionally arranged in combination.

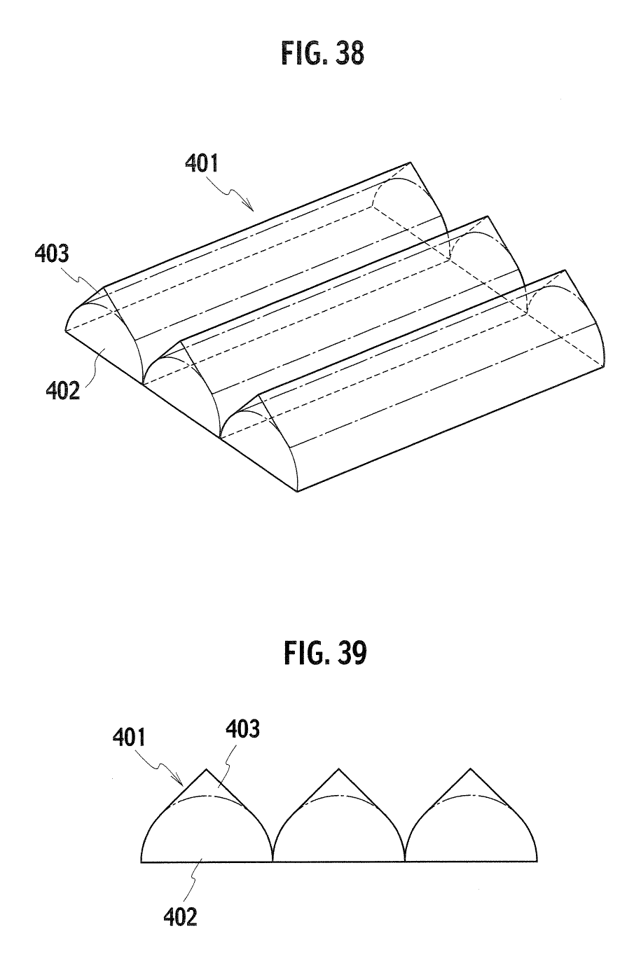

The first embodiment may include a plurality of one-dimensionally extending prism units 401 which are arranged side by side. Refer to FIG. 38. In such a case, each prism unit is constituted by a semi-cylindrical lens 402 and a prism 403 placed on the semi-cylindrical lens 402 and having an apex angle of 90 degrees.

In each embodiment as referred to above, the display device can select the reflective mode or the transmissive mode, and assure brighter images.

What is claimed is:

1. A display device comprising:
a prism layer including a plurality of prisms on a surface thereof;
a support layer facing with the prisms on the prism layer;
a medium layer placed between the prism layer and the support layer, and including a first medium having a first refractive index and a second medium having a second refractive index, the first and second media being freely movable in the medium layer; and
electrodes supplying a potential difference between the prism layer and the support layer.

2. The display device defined in claim 1, wherein a refractive index n₀ of the prism layer is larger than a refractive index n₁ of the first medium, and a refractive index n₂ of the second medium is larger than the refractive index n₁, i.e., n₀>n₁, and n₂>n₁.

3. The display device defined in claim 1, wherein the first medium is an insulating solvent, and the second medium is resin particles.

4. The display device defined in claim 1 further comprising:
a liquid crystal layer;
a light source facing with the liquid crystal layer; and
a selector placed between the liquid crystal layer and the light source, including the prism layer, the medium layer and the support layer all of which face with the liquid crystal layer, and changing reflection of light beams over to transmission light beams and vice versa in response to a polarity of a difference in potentials applied between the prism layer and the support layer, the light beams arriving via the liquid crystal layer.

5. The display device defined in claim 1, wherein the electrodes are a first transparent electrode placed on a surface of the prism layer facing with the medium layer, and a second transparent electrode placed on a surface of the support layer facing with the medium layer.

6. The display device defined in claim 4, wherein the electrodes is a first transparent electrode placed on a surface of the prism layer facing with the medium layer, and a second transparent electrode placed on a surface of the support layer facing with the medium layer.

7. The display device defined in claim 1, wherein the medium layer is split into regions, each of which includes at least one of the prisms, and includes the electrodes.

8. The display device defined in claim 7 further comprising a control unit which causes severally a potential difference between the electrodes in the split region.

9. The display device defined in claim 1, wherein the prism layer includes a plurality of the prisms on a surface thereof, the prisms being arranged in parallel and extending in one direction.

10. The display device defined in claim 4, wherein the prism layer includes a plurality of the prisms on a surface thereof, the prisms being arranged in parallel and extending in one direction.

11. The display device defined in claim 9, wherein a plurality of the prism layers and a plurality of the medium layers extend in different directions and are stacked.

12. The display device defined in claim 10, wherein a plurality of the prism layers and a plurality of the medium layers extend in different directions and are stacked.

13. The display device defined in claim 1, wherein the prism layer includes a plurality of the prisms which are in the shape of a quadrilateral pyramid, and are two-dimensionally arranged on the surface of the prism layer.

14. The display device defined in claim 4, wherein the prism layer includes a plurality of the prisms which are in the shape of a quadrilateral pyramid, and are two-dimensionally arranged on the surface of the prism layer.
